(19) United States
(12) Patent Application Publication
(10) Pub. No.: US 2017/0325604 A1
(43) Pub. Date: Nov. 16, 2017

(54) Mirror Customization Kit

(71) Applicants: Tamara R. Hoerner, Aurora, CO (US); James Hoerner, Aurora, CO (US)

(72) Inventors: Tamara R. Hoerner, Aurora, CO (US); James Hoerner, Aurora, CO (US)

(21) Appl. No.: 15/592,415

(22) Filed: May 11, 2017

Related U.S. Application Data
(60) Provisional application No. 62/334,919, filed on May 11, 2016.

(51) Int. Cl. A47G 1/06; A45D 42/18; G02B 27/22; A47G 1/00

(52) U.S. Cl. CPC A47G 1/0616; G02B 27/2278; A45D 42/18; A47G 2001/005

(57) ABSTRACT

A mirror customization kit. The mirror customization kit includes a plurality of adhesive fasteners for securing a plurality of accessory attachments to a mirrored surface, allowing individuals to customize and personalize the appearance of the mirror. The accessory attachments may include a gift card pocket, rhinestones, static cling vinyl images, and a stackable image having multiple layers configured to be secured to the mirrored surface in a stacked arrangement in order to form a three-dimensional image. In one embodiment, the kit includes a base having a mirror thereon. One example base includes a card having a first panel hingedly connected to a second panel, wherein the mirror is disposed on an interior side of either one of the first panel or second panel.

### CROSS REFERENCE TO RELATED APPLICATIONS

This application claims the benefit of U.S. Provisional Application No. 62/334,919 filed on May 11, 2016. The above identified patent application is herein incorporated by reference in its entirety to provide continuity of disclosure.

### FIELD OF THE INVENTION

The present invention relates to customization kits. More specifically, the present invention provides a mirror customization kit that includes a plurality of accessory attachments for customizing and personalizing the appearance of a mirrored surface.

### BACKGROUND OF THE INVENTION

Many individuals utilize a mirror on a daily basis. Should individuals wish to personalize a mirror, it can be difficult to assemble a number of matching decorations and attachments. Further, it can be difficult for an individual to find the exact images or messages the individual wants. Individuals may be unable to alter the mirrored surface without damaging it or rendering it unusable. Therefore, it is desirable to provide a mirror customization kit that includes a plurality of accessory attachments securable to a mirrored surface so that individuals can easily create a customized and personalized mirror.

Devices have been disclosed in the known art relating to mirror customization kits. These include devices that have been patented and published in patent application publications. The devices generally relate to kits that include a variety of accessory attachments. However, the devices in the known art have several drawbacks. The devices in the known art fail to provide a combination of accessory attachments that includes static cling images, stackable image accessories, rhinestones, and a gift card pocket. Further, the devices in the known art fail to provide a mirror customization kit that includes a base having a mirror thereon.

In light of the devices disclosed in the known art, it is submitted that the present invention substantially diverges in design elements from the known art and consequently it is clear that there is a need in the art for an improvement to existing mirror customization kits. In this regard the present invention substantially fulfills these needs.

### SUMMARY OF THE INVENTION

In view of the foregoing disadvantages inherent in the known types of mirror customization kits now present in the prior art, the present invention provides a mirror customization kit wherein the same can be utilized for providing convenience for the user when creating a customized and personalized mirrored surface. The mirror customization kit includes a plurality of adhesive fasteners comprising a first side having an adhesive material thereon and a second side having an adhesive material thereon that are utilized to secure a plurality of accessory attachments to a mirrored surface. One accessory attachment includes a gift card pocket comprising a closed lower end, an open upper end, and an interior volume therebetween, the gift card pocket securable to a surface via at least one of the plurality of adhesive fasteners. A static cling image is included that is configured to be removably secured to a mirrored surface. Further included are a plurality of rhinestones comprising a first side having a gem thereon and a second side having an adhesive material thereon.

One object of the present invention is to provide a mirror customization kit that includes a base having a mirror thereon that can be personalized and customized depending on the occasion.

Another object of the present invention is to provide a mirror customization kit that includes an image accessory that includes a first layer and a second layer, wherein the first layer and the second layer are securable to a surface in a stacked arrangement in order to form a three-dimensional image.

Other objects, features, and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the components of mirror customization kit.

FIG. 2 shows a cross-sectional view of the components of the mirror customization kit secured to a surface.

### DETAILED DESCRIPTION OF THE INVENTION

Reference is made herein to the attached drawings. Like reference numerals are used throughout the drawings to depict like or similar elements of the mirror customization kit. For the purposes of presenting a brief and clear description of the present invention, the preferred embodiment will be discussed as used for creating a customized and personalized mirrored surface. The figures are intended for representative purposes only and should not be considered to be limiting in any respect.

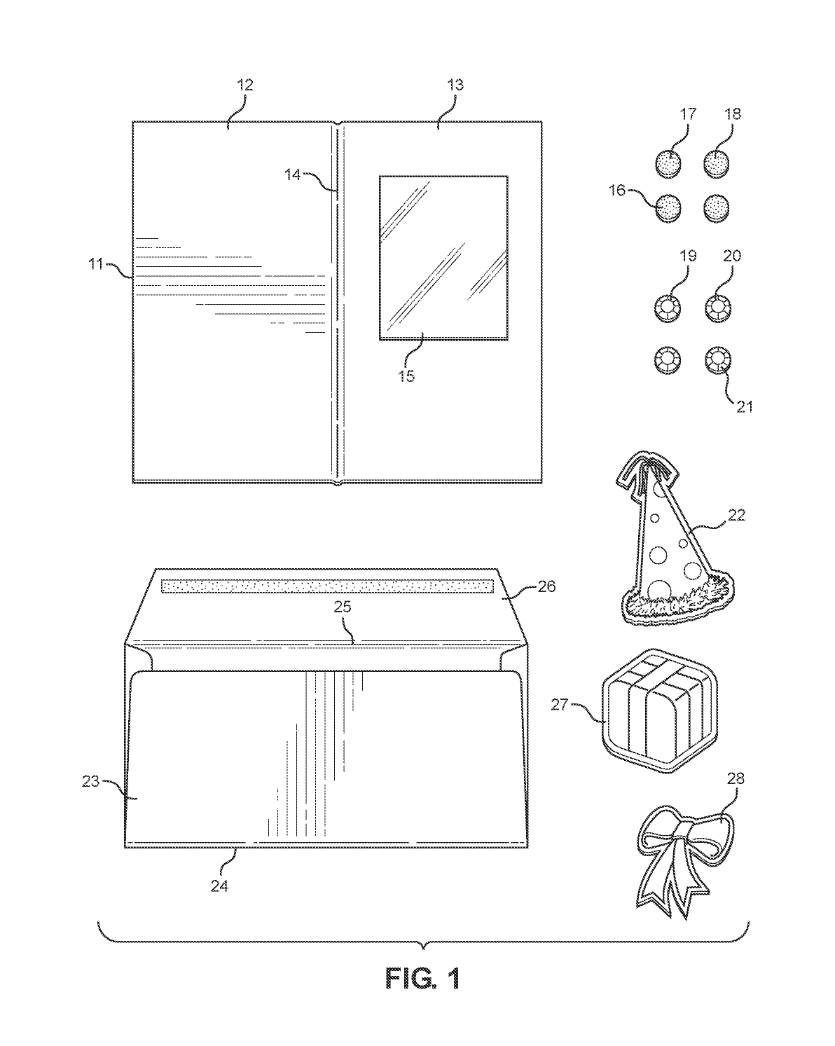

Referring now to FIG. 1, there is shown a perspective view of the components of mirror customization kit. A variety of accessory attachments are provided for customizing a mirror 15. One accessory attachment includes a plurality of rhinestones 19 having a gem on a first side 21 thereof and an adhesive second side 20. The rhinestones 19 may be adhered to the mirror 15 or a base 11 to which the mirror is attached. Another accessory attachment includes a static cling image 22 that may be removably secured to the mirror 15. In one embodiment, the static cling image 22 is non-adhesive and sticks to the mirror 15 by creating a suction force when placed flush thereagainst. Thus, the static cling image 22 can be removed and reused if desired without damaging the mirror 15.

A further accessory attachment includes a gift card pocket 23 configured to receive a gift card therein. The gift card pocket 23 includes a closed lower end 24 and an open upper end 25 defining an interior volume sized to receive a gift card. In one embodiment, the gift card pocket 23 includes a closure flap 26. The closure flap 26 can be positioned over the open upper end 25 in order to seal a gift card within the gift card pocket 23. The closure flap 26 is secured via an adhesive material thereon. The gift card pocket 23 is securable to the base 11 or mirror 15 via one or more adhesive tabs 16 that are included with the mirror customization kit. The adhesive tabs 16 include a first adhesive side 17 and a second adhesive side 18. In an alternate embodiment, the gift card pocket 23 includes suction cups thereon for removable securement to the mirror 15.

In one embodiment, the mirror customization kit includes a base 11 having a mirror 15 thereon. The base 11 and mirror 15 can be customized and personalized with the provided accessories according to an occasion, such as a birthday or graduation. In the illustrated embodiment, the base 11 is rectangular and includes a first panel 12 panel connected to a second panel 13 via a hinged portion 14 therebetween. The hinged portion 14 may be a fold in the base 11. Other embodiments can include different shapes for the base 11, such as circular, square, triangular, or the like. Additionally, some embodiments may allow the base 11 to be folded into any shape or include any number of panels according to individual preference.

In the illustrated embodiment, another accessory attachment includes a stackable image having at least a first layer 27 and a second layer 28. The first layer 27 is securable to the base 11 or mirror 15 via the adhesive tabs 17, and the second layer 28 is securable to the first layer 27 via the adhesive tabs 17, forming a stacked three-dimensional image. The first layer 27 and second layer 28 project outward from the surface to which they are secured, creating a three-dimensional image that projects outward from the base 11 or mirror 15. In the shown embodiment, the first layer 27 is depicts a gift box and the second layer 28 depicts a bow. The bow can be attached to the gift box which creates a three-dimensional image projecting outward from the base 11.

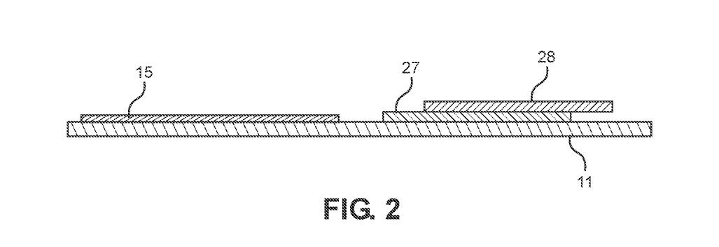

Referring now to FIG. 2, there is shown a cross-sectional view of the components of the mirror customization kit secured to a surface. The first layer 27 of the stackable image is shown secured to the base 11 adjacent the mirror 15. The second layer 28 is secured to the first layer 27. The second layer 28 may extend outward past an edge of the first layer 27 in order to create depth to the image. In the illustrated embodiment, only two layers are shown. However, the three-dimensional image can be created with a greater amount of layers in order to show more depth.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A mirror customization kit, comprising:
a plurality of adhesive fasteners comprising a first side having an adhesive material thereon and a second side having an adhesive material thereon;
a gift card pocket comprising a closed lower end, an open upper end, and an interior volume therebetween, the gift card pocket securable to a mirrored surface at least one of the plurality of adhesive fasteners;
a static cling image configured to be removably secured to a mirrored surface;
a plurality of rhinestones comprising a first side having a gem thereon and a second side having an adhesive material thereon.

2) The mirror customization kit of claim 1, wherein the gift card pocket further comprises a closure flap configured to selectively prevent or allow access to the interior volume.

3) The mirror customization kit claim 2, wherein the closure comprises an adhesive material thereon.

4) The mirror customization kit of claim 1, further comprising stackable image comprising a first side having a decorative image thereon and a second side securable to a mirrored surface at least one of the plurality of adhesive fasteners.

5) The mirror customization kit of claim 4, wherein the stackable image comprises a first layer and a second layer, wherein the first layer is securable to the second layer via at least one of the plurality of adhesive fasteners, wherein the first layer and the second layer are configured to be secured to a surface in a stacked arrangement to form a three-dimensional image.

6) The mirror customization kit of claim 1, further comprising a base having a mirror thereon.

7) The mirror customization kit of claim 6, wherein the base comprises a first panel hingedly connected to a second panel.

8) The mirror customization kit of claim 6, wherein the first panel and the second panel each comprise an inner side and an outer side, wherein the mirror is disposed on an inner side of either one of the first panel or the second panel.
